(19) United States
(12) Patent Application Publication
(10) Pub. No.: US 2007/0251955 A1
(43) Pub. Date: Nov. 1, 2007

(54) Liquid container valve system

(76) Inventor: Theodore Augustus Green, Westminster, CA (US)

Correspondence Address: CISLO & THOMAS LLP, 233 WILSHIRE BOULEVARD, SUITE 900, SANTA MONICA, CA, 90401-1211, US

(21) Appl. No.: 11/410,667

(22) Filed: Apr. 26, 2006

(51) Int. Cl. B67D 5/06

(52) U.S. Cl. 222/185.1

(57) ABSTRACT

A liquid beverage dispenser includes a stabilizing base with a concave upwardly facing, internally threaded socket that can be screwed onto the externally threaded neck of a plastic beverage container to create a fluid tight coupling. The base supports the beverage container in an inverted orientation so that the mouth of the beverage container empties downwardly into the socket of the dispenser. The dispenser socket is provided with a vent tube that projects upwardly from an air relief port in the socket floor. A beverage drain port is also located in the floor of the socket, but is separated from the air relief port. A spigot is located at the outer periphery of the dispenser base so that liquid flows from the mouth of the bottle, through the drain port, and out of the spigot when the spigot is open. A rubber, one-way air relief check valve is mounted at the upper extremity of the vent tube and within the bottle. As the liquid beverage flows out of the bottle under the control of the spigot, the volume of the liquid beverage withdrawn is replaced by air that enters the bottle through the air relief port and the one-way valve. Air bubbles up from the one-way valve into the bottle replacing the liquid as it is withdrawn. Pressure is thereby equalized within the bottle.

### BACKGROUND OF THE INVENTION

1. Field of the Invention

The present invention relates to a valve system for dispensing liquid from a container, such as a plastic beverage container, in a controlled manner.

2. Description of the Prior Art

Plastic bottles with threaded necks are now extensively used as commercial containers for beverages sold to consumers. Plastic bottles of this type are widely utilized as containers for soft drinks, nonalcoholic drink mixes, bottled water, and other beverages. Beverage containers of this type are widely sold in supermarkets and grocery stores. Beverages are sold in plastic bottles having a wide variety of sizes, ranging from small sizes of just a few ounces, up to larger sizes of one, two, and even three liters.

Conventional plastic beverage containers are produced with narrow necks at their upper extremities that surround open mouths through which the beverages are poured. The necks are externally threaded to receive an internally threaded plastic or metal cap. The threads are configured so that the cap, when threadably engaged upon the neck of the container, is sealed fluid tight.

When consumers open plastic beverage containers of this type to dispense beverages therefrom, care must be taken in holding the container so that the contents are not spilled while tilting the container to pour the beverage therefrom into a cup or glass. To reduce the cost of plastic beverage bottles the container walls are typically rather thin. Due to the resiliency of the structure of plastic beverage containers, the contents can easily be spilled during pouring of the beverage due in large part to the flexible nature of the walls of the beverage container. This problem is particularly acute in pouring beverages from containers of larger sizes, such as two and three-liter plastic bottles. It is not at all uncommon for portions of the plastic wall of the bottle to collapse suddenly under pressure exerted by the fingers of the individual pouring the beverage as liquid is being poured. When this occurs the beverage often spills.

Spills while pouring beverages from large plastic beverage containers quite often occur when the beverage is being poured by a child. Due to the small size of a child's hands, and inexperience in controlling the position of the beverage bottle, children frequently spill beverages when pouring them from their plastic containers into cups or glasses. Such spills not only represent a waste of the beverage, but also require cleanup. Furthermore, when beverages spill in this manner the spilled liquid soils table cloths and napkins, and renders paper table cloths and paper napkins unusable.

The manufacturers of wine in a box containers outsell their competitors two to one due to the convenience of having wine in a large container that is easily accessible on a refrigerator shelf or picnic table. However, the wine in such containers is stored in a collapsible bladder, unlike plastic soft drink and other beverage containers which are stiff enough so that they can hold their shape on the shelves of a retail supermarket and during storage by the consumer once purchased.

The use of two liter bottles by consumers is not particularly convenient due to their size and weight. However, the cost of a two liter plastic bottle is considerably less than the cost of an equivalent amount of twelve ounce cans. Furthermore, the two liter bottles themselves represent an attractive marketing package to consumers. Therefore, two liter plastic beverage bottles are widely utilized to package consumer beverages sold for off-premises consumption.

### SUMMARY OF THE INVENTION

The present invention provides a controlled valve system for use with plastic containers to avoid spills and messes of the type that so frequently occur when manually pouring a beverage from a plastic container, particularly a large plastic container such as a two liter bottle.

The present invention provides an apparatus for controlling delivery of a beverage from an inverted beverage container. The apparatus may be considered to be a dispenser formed with a stable base. The dispenser base is substantially the same diameter as the bottle it is designed to accommodate. It may have a generally disc-shaped configuration or it may be shaped substantially in the configuration of a spoked wheel.

The base has a flat undersurface with a concave upwardly directed socket at its center that is internally threaded to match the external threads formed on the necks of the size of plastic container the dispenser is designed to accommodate. For example, the socket of the dispenser may be internally threaded to receive the external threads on the neck of a two liter bottle in fluid tight, sealed engagement. Instead of pouring a beverage directly from a two liter plastic container, the threaded cap of the container is removed and the dispenser of the invention is inverted. The socket at the center of the dispenser is screwed onto the neck of the two liter bottle. The bottle is then inverted so that it is mounted neck down and supported by the dispenser, which can rest upon a flat surface, such as a table.

The socket formed in the dispenser has separate relief and liquid drain ports. The socket is equipped with a vent tube that may extend up from the air relief port located at the center of the floor of the socket to above the edge of the socket wall and into the bottle. A one-way check valve is mounted on the upper extremity of the vent tube.

The check valve is preferably formed of a soft, flexible material, such as rubber, configured into a tubular configuration. Preferably, the check valve is formed as a pair of congruent rubber layers having a generally trapezoidal configuration and secured together along their nonparallel edges by fusion or other means, so that the rubber layers normally reside in face to face contact with each other. The layers of rubber are not sealed across their parallel edges. Instead, the shorter parallel edges of the trapezoidal layers form an air inlet opening that may be snugly secured to the upper end of the vent tube. The longer parallel edges of the rubber layers are also not sealed, so that an air outlet opening is formed between them.

With a check valve configured in this manner, formed of a pair of rubber flaps sealed along their edges, the omnidirectional pressure of the liquid within the bottle forces the layers of rubber together above the lever of the vent tube, so that liquid cannot escape through the check valve. Nevertheless, when pressure within the bottle falls below ambient air pressure, the outside air pressure forces air up between the layers of rubber, thereby equalizing air pressure inside and outside the bottle.

The liquid drain opening is formed in the socket floor to one side of the vent tube, off center within the socket. The drain opening is in communication-with an enclosed conduit that leads to a spigot mounted on the peripheral edge of the dispenser base.

When the socket of the dispenser is threaded onto the neck of the bottle and the dispenser is placed upon a supporting surface, such as a table or counter, the mouth of the bottle is oriented perpendicular to a lateral beverage delivery tube that begins at the drain opening. The beverage delivery tube extends to the perimeter of the base where it terminates at the spigot. The air relief port at the bottom of the vent tube is connected by an air relief passageway that extends from the floor of the socket, laterally through the structure of the dispenser so that the vent tube communicates with outside ambient air.

When the liquid beverage is dispensed by opening the spigot with a cup or glass positioned beneath the spigot, the liquid beverage flows from the inverted mouth of the bottle, down the drain opening, laterally through the enclosed beverage delivery conduit, and out through the spigot. As the volume of liquid within the bottle diminishes, there is a drop in air pressure within the bottle above the level of the liquid. This reduced air pressure tends to create a partial vacuum that would normally inhibit, or even totally stop, flow of liquid from the spigot.

However, by employing the check valve of the invention which is in communication with ambient air, the differential in pressure is relieved as liquid flows from the bottle. When the pressure of the liquid within the bottle drops to below ambient air pressure, air will flow through the one-way check valve from ambient atmosphere up through the air relief port in the socket, through the vent tube, and through the collapsible check valve up into the bottle. Since the ambient air is far less dense than the liquid beverage, it will immediately bubble to the inverted bottom of the bottle, thereby equalizing air pressure within the bottle to ambient air pressure. It is thereby possible to continue to dispense the liquid beverage from the spigot, as desired, without a disruption of flow due to development of a partial vacuum within the bottle.

By providing a pressure equalizing beverage dispensing system according to the invention, a beverage can be conveniently dispensed from the spigot of the dispenser with far less likelihood of spilling and in a much more controlled manner than is possible by pouring the beverage from the plastic container.

In one broad aspect the present invention may be considered to be a liquid dispenser for use with a closed liquid beverage container having a mouth. The dispenser of the invention is comprised of a container stabilizing base having a concave upwardly facing socket for receiving the container mouth. The socket has a lower portion and a cylindrical annual socket wall rising upwardly therefrom. A liquid drain port is located in the socket lower portion. Similarly, an air relief port is located in the socket lower portion and is separate from the liquid drain port. A manually operable spigot is located on the base and is laterally displaced from the socket. An enclosed conduit leads from the liquid drain port to the spigot. An air passageway is defined within the base and extends between the air relief port and ambient air surrounding the base. A check valve serving as an air relief valve is secured in sealed communication with the air relief port. The check valve admits ambient air flow into the socket through the air relief port while preventing flow of liquid out of the socket through the air relief port.

While the dispenser of the invention can be utilized with different types vessels for storing liquids, it is advantageously employed in combination with a liquid beverage container having a narrow, externally threaded neck surrounding an open mouth. Therefore, the annular socket wall of the dispenser is preferably internally threaded to receive an externally threaded neck that surrounds the mouth of a closed liquid beverage container.

Also, the socket lower portion preferably includes a transverse socket floor located beneath the internal threads on the wall of the socket. The socket floor is located at the bottom of and is surrounded by the socket wall. Both the liquid drain port and the air relief port are preferably formed in the socket floor.

The socket is preferably formed with an air vent tube extending upwardly from the air relief port in the socket floor to above the level of the annular socket wall. The air vent tube terminates in a distal tip with an annular check valve-engaging neck located at the distal tip.

The check valve is preferably comprised of a flexible sleeve having an open lower inlet end engaged on the annular check valve-engaging neck and an opposite, open collapsible, upper outlet end. The flexible sleeve is preferably formed from a single sheet of liquid impervious material, such as rubber, configured in the shape of a pair of mirror image trapezoidal portions sharing a common minor base. The sheet of material may also be described as having a “butterfly” shape.

The rubber sheet of material is perforated at the center of the common minor base and the nonparallel sides of each of the mirror image trapezoidal portions are sealed together throughout their lengths. The nonparallel sides of each trapezoidal portion are sealed to the corresponding nonparallel sides of the other trapezoidal portion. As a result, the common minor base of the mirror image trapezoidal portions forms the lower inlet end of the check valve. The nonparallel sides are preferably sealed by fusion, although they can be sealed by means of an adhesive.

In another broad aspect the invention may be considered to be an apparatus for controlled delivery of a beverage from an inverted beverage container. The apparatus of the invention is comprised of a container stabilizing base having a concave upwardly directed socket defining a cylindrical, annular socket wall open at its top and including a beverage container coupling. A liquid drain port is formed in the socket beneath the beverage container coupling. An air relief port is formed in the socket separate from the liquid drain port and is also located beneath the beverage container coupling. A manual liquid dispensing valve is located on the base in lateral displacement from the socket. The manual dispensing valve is operable to selectively block and permit passage of liquid therethrough. A liquid passage is formed through the structure of the base and extends between the liquid drain port and the manual dispensing valve. The liquid passageway is isolated from ambient air. An air passageway in the base extends between the air relief port and ambient air. An air relief check valve is secured in sealed communication with the air relief port to admit air flow therefrom and prevent liquid flow thereto.

In still another broad aspect the invention may be considered to be a combination of a beverage container stand and an inverted beverage container. The beverage container stand has a periphery and a central, concave upwardly facing socket having a floor surrounded by an upright, cylindrical socket wall. A liquid drain port and a separate air relief port are both defined in the socket floor. A spigot is provided for dispensing liquid and is located at the periphery of the stand. A laterally enclosed liquid passage extends from the spigot to the liquid drain port.

An air passage extends from the air relief port to ambient atmosphere. A one-way valve is provided in sealed communication with the air relief port and is oriented to admit fluid flow through the air relief port into the socket and prevent fluid flow from the socket out of the air relief port. The inverted beverage container has a mouth with a neck and contains liquid. The neck of the beverage container is sealed fluid tight to the upright socket walls so that the mouth of the beverage container resides in open communication with the socket floor.

Preferably, the beverage container is a plastic, multiliter bottle, the neck of which is externally threaded. The upright socket wall is formed with mating threads on its internal surface.

An air inlet tube extends from the air relief port upwardly to above the cylindrical wall. The one-way valve is attached to the upper extremity of the air inlet tube.

The one-way valve is preferably formed of a flexible, water impervious material shaped as a collapsible, tubular structure. This structure has an inlet with an inlet opening therein and is releaseably coupled to the upper extremity of the air inlet tube. It also has an opposite outlet end with an outlet opening therein. The tubular structure is formed from a pair of congruent layers of flexible rubber sealed along their side edges between the inlet and outlet openings.

The invention may be described with greater clarity and particularity by reference to the accompanying drawings.

### DESCRIPTION OF THE DRAWINGS

FIG. 1 is a perspective view illustrating the dispenser of the invention employed in combination with a two liter plastic beverage container.

FIG. 2 is a sectional elevational detail illustrating the operative components of the liquid dispenser of the invention.

FIG. 3 is a sectional plan view taken along the lines 3-3 of FIG. 2.

FIG. 4 illustrates a single sheet of material utilized to form the one-way check valve of the invention.

FIG. 5 is a side elevational view illustrating the one-way air relief valve of the invention in isolation.

### DESCRIPTION OF THE EMBODIMENT

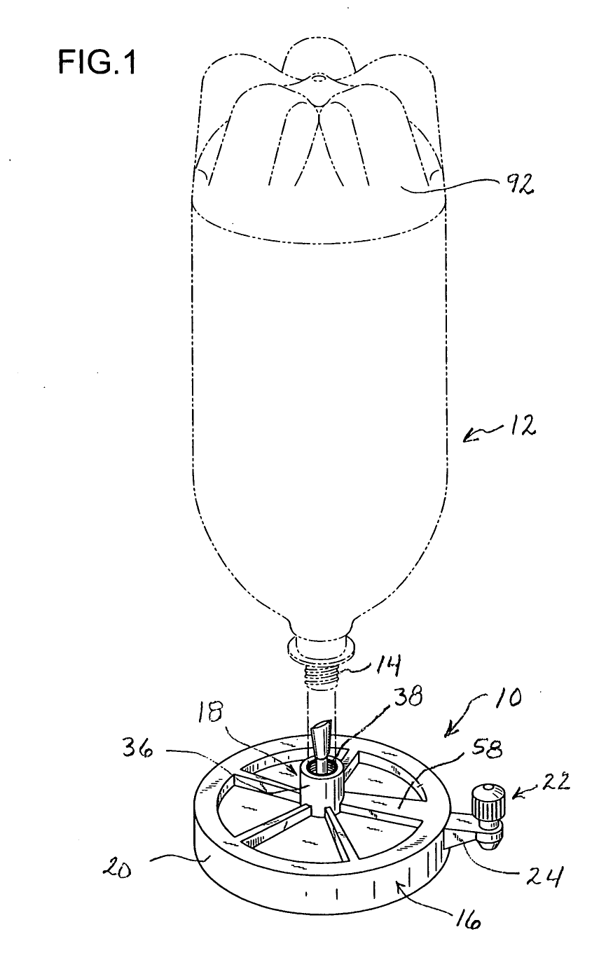

As illustrated in FIG. 1, a liquid beverage dispenser 10 is shown in combination with a two liter plastic beverage bottle 12. The plastic beverage container 12 is inverted when utilized in combination with the dispenser 10 and has a mouth surrounded by an externally threaded neck 14.

The dispenser 10 has a base 16 has a flat underside and is formed as a spoked, wheel-shaped structure with a hub in the shape of a concave upwardly facing socket 18. The base 16 also has a peripheral rim 20 upon which a spigot 22 is mounted by means of a spigot arm 24.

The spigot 22 is a conventional structure and includes an internally threaded valve closure cap 26 having a valve closure post 27 that extends coaxially down the hollow center of a valve body 28. Rotation of the spigot cap 26 in a clockwise direction carries the valve closure member 27 downwardly, blocking a beverage dispensing opening 30. Counterrotation of the spigot cap 26 retracts the valve closure element 27 upwardly, thereby allowing liquid to flow out of the liquid dispensing port 30, as indicated by the directional arrow 32. The spigot 22 thereby can be utilized to dispense liquid in a highly controlled manner into a series of plastic or paper cups 34 for consumption.

The socket 18 has a cylindrical annular upwardly projecting socket wall 36 having an upper portion that is formed with internal screw threads 38. The screw threads 38 are of the same size and pitch as the threads on the neck 14 of the two liter beverage bottle 12. Therefore, when the beverage container 12 is in an upright condition opposite that illustrated in the drawings, the cap with which it is sold can be removed and the dispenser 10 can be attached to the neck 14 by screwing the socket 18 onto the bottle neck 14. A fluid tight seal is thereby created between the neck 14 of the bottle 12 and the socket 18. The socket 18 is formed with a transverse floor 44 that is located at the bottom of the socket wall 36. The socket wall 36 thereby surrounds the socket floor 44 and rises from it.

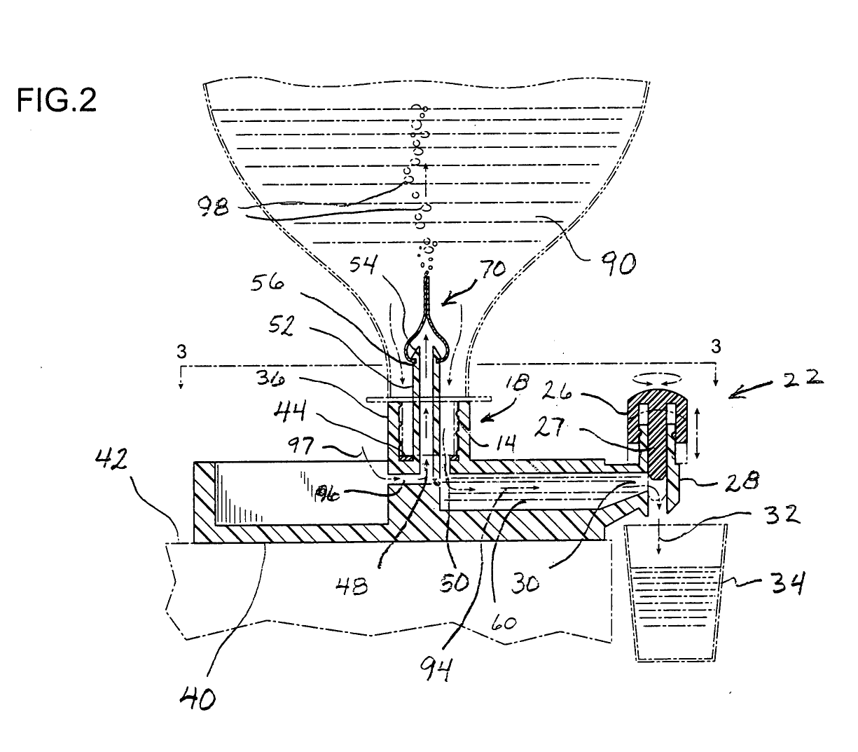

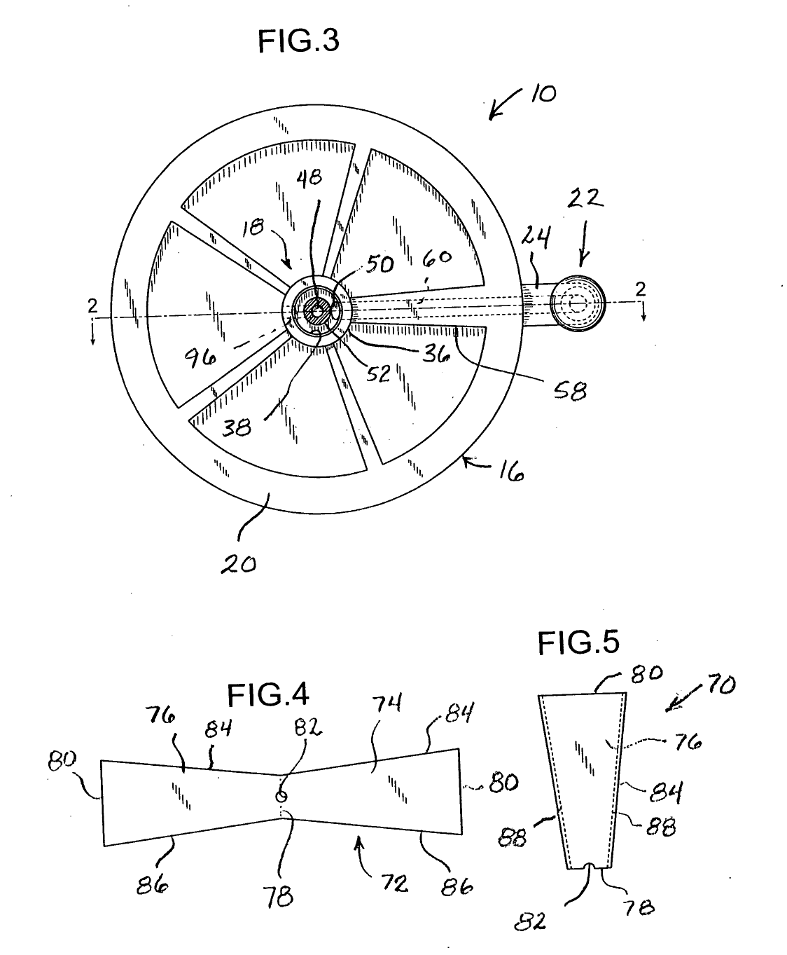

The combination of the dispenser 10 with the two liter plastic bottle 12 mounted thereto can then be turned upside down. The flat underside 40 of the dispenser body 16 can be placed atop a flat serving surface, such as the table or counter 42 indicated in FIG. 2.

A central air relief port 48 is defined in the floor 44 of the socket 18, and a separate liquid beverage drain port 50 is also formed in the socket floor 44. The beverage drain port 50 is separate and is isolated from the air relief port 48.

The socket 18 is also provided with an air vent or inlet tube 52 that extends upwardly from the air relief port 48 in the socket floor 44. The air vent tube 52 extends above the top of the annular socket wall 36 and terminates in a distal tip 54 with an annular check valve-engaging barbed neck or collar 56 located immediately beneath the distal tip 54.

The dispenser base 16 is formed with a plurality of spokes extending between the socket 18 and the peripheral rim 20. The spoke 58 is hollow and forms a liquid passageway 60 that extends laterally outwardly from the liquid drain port 50 to the liquid dispensing opening 30, which is opened and closed by the spigot 22.

A critical feature of the invention is the one-way check valve indicated at 70. The check valve 70 is formed from a single sheet of soft rubber 72, which in its initial condition is configured generally in a “butterfly” shape, as illustrated in FIG. 4. That is, the rubber sheet 72 is configured in the shape of a pair of mirror image, trapezoidal portions 74 and 76, sharing a common minor base indicated in dashed lines at 78. The opposite major bases 80 of the trapezoidal portions 74 and 76 are parallel to the common minor base 78. The sheet of material 72 is perforated at the center of the common minor base with a circular opening 82.

The layers of sheet rubber formed by the trapezoidal portions 74 and 76 are folded into congruent relationship relative to each other, as illustrated in FIG. 5. The mutually congruent, nonparallel sides 84 and 86 of the trapezoidal portions 74 and 76 are placed in contact with each other and are sealed together throughout their lengths, preferably by fusion, as indicated by the lines of sealing 88 in FIG. 5.

Once the nonparallel sides of the trapezoidal portions 74 and 76 have been sealed together along the lines of sealing 88, the common base 78 of the trapezoidal portions 74 and 76 forms the lower inlet end of the one-way check valve 70 and the perforation 82 forms the inlet opening. The opposite, major bases 80 of the trapezoidal portions 74 and 76 are not sealed to each other, but do normally reside in face to face contact with each other. They are held pressed together by the hydrostatic pressure of the surrounding liquid beverage 90 in the inverted plastic bottle 12.

As illustrated in FIG. 2, the lower end of the flexible rubber check valve 70 is attached to the upper tip 54 of the vent tube 52 in releaseable, but fluid tight engagement by stretching the rubber at the common minor trapezoid base 78 so that the upper distal tip 54 of the vent tube 52 can be inserted through the inlet opening 82. The rubber of the sheet 72 is resilient enough so that a fluid tight seal is formed between the lower end of the check valve 70 and the barbed neck 56 below the distal tip 54 of the vent tube 52.

The sheet of rubber 72 is a soft, flexible, resilient material. The one-way check valve 70 is releaseably engaged on the vent tube 52, as illustrated in FIG. 1, prior to attachment of the socket 18 to the neck 14 of the bottle 12.

Once the bottle neck 14 has been screwed into the socket 18 and the dispenser 10 and once the bottle 12 is inverted, as illustrated in FIG. 2, liquid will flow down into the open mouth of the bottle 12, but cannot escape through the liquid drain opening 50 until such time as the spigot 22 is opened. Due to the flexible nature of the rubber sheet 72, the upper end of the one-way check valve 70 at the trapezoid base edges 80 will remain collapsed with the layers forming the upper end of the check valve 70 pressed together by the hydrostatic pressure of the liquid beverage 90 in the bottle 12.

The dispenser base 16 is positioned on the serving surface 42 so that the spigot 22 projects outwardly beyond the edge of the serving surface 42, held in cantilever fashion by the spigot mounting arm 24. The cap 26 of the spigot 22 can them be opened and closed very easily to dispense the liquid beverage 90 into the cups 34 as each cup 34 is brought into position beneath the outlet of the spigot 22.

The plastic bottle 12 has a structure that is sufficiently rigid so that it will collapse to only a limited extent as the liquid beverage 90 flows out of the bottle 12 and into the cups 34 as controlled by the spigot 22. As a consequence, without the one-way valve 70 of the invention, a partial vacuum would be created in the upper region 92 of the bottle 12 as liquid is drawn out of the mouth and through the liquid passage 60 for dispensation into the cups 34. The withdrawal of a significant volume of the liquid 90 from the bottle 12 would create a partial vacuum in the upper region 92 of the inverted bottle 12. A partial vacuum would inhibit or completely halt liquid flow from the spigot 22. However, the one-way valve 70 permits the volume of liquid 90 being withdrawn from the bottle 12 to be replaced by ambient air. As liquid flows out of the bottle 12, as indicated by the directional arrow 94, air flows into the air relief passageway 96 defined in the dispenser base 16 beneath the socket floor 44, as indicated by the directional arrow 97.

The pressure of ambient air acts through the air relief port 48, within the hollow vent tube 52, and allows air to bubble upwardly, momentarily spreading apart the upper ends of the trapezoidal portions 74 and 76 of the check valve 70. Air bubbles 98 are thereby vented into the bottle 12 to replace the volume of the beverage 90 dispensed and to equalize pressure within the plastic bottle 12 so that dispensation of beverage flow through the spigot 22 is not disrupted. The relief of air pressure through the check valve 70 within the bottle 12 allows liquid beverage to flow smoothly out of the dispenser 10 and into the cups 34, as controlled by the spigot 22.

The hydrostatic pressure of the liquid beverage 90 within the lower portion of the bottle 12 normally holds the upper ends of the trapezoidal portions 74 and 76 of the valve 70 in face to face contact with each other, thereby creating a fluid tight seal, as long as the spigot 22 is closed. However, due to the sandwich-like construction of the trapezoidal flaps 74 and 76, air is allowed to pass between the two rubber layers forming the check valve 70 when a vacuum builds up in the upper region 92 of the bottle 12 as the liquid beverage 90 is drained out through the drain port 50. As a partial vacuum develops in the bottle 12, air is allowed to pass between the two rubber layers 74 and 76 when there is a lower pressure inside the bottle 12 relative to ambient atmosphere. However, the beverage 90 is unable to escape between the trapezoidal flaps portion 74 and 76 and into the vent tube 52, since the hydrostatic pressure of the liquid beverage causes the rubber layers 74 and76 collapse back against each other, once the air bubbles pass between them.

While the combination of the inverted bottle 12 with the dispenser 10 is illustrated in FIG. 2 for dispensing liquid over the edge of a supporting surface, such as a table 42, it can also be stored in this condition in a refrigerator. Thus, the bottle 12 can sit cold on a refrigerator shelf with the spigot 22 extending just beyond the shelf. The straight liquid beverage passage 60 leading from the central socket 18 of the dispenser body 16 gives the dispenser 10 a low profile. This ensures that the bottle 12 and dispenser 10 can fit on a typical refrigerator shelf.

Undoubtedly, numerous variations and modifications to the invention are possible. For example, different types of check valves can be employed in place of the check valve 70 illustrated in the drawings. Also, the configuration of the base 16 of dispenser 10 can have many different shapes. Accordingly, the scope of the invention should not be construed as limited to the specific embodiment depicted and described, but rather is defined in the claims appended hereto.

I claim:

1. A liquid dispenser for use with a closed liquid beverage container having a mouth comprising:
a container stabilizing base having a concave upwardly facing socket z for receiving said container mouth, said socket having a lower portion with a cylindrical annular socket wall rising upwardly therefrom,
a liquid drain port located in said socket lower portion,
an air relief port located in said socket lower portion and separated from said liquid drain port,
a manually operable spigot located on said base and laterally displaced from said socket,
an enclosed conduit leading from said liquid drain port to said spigot,
an air passageway defined within said base and extending between said air relief port and ambient air surrounding said base, and
a check valve serving as an air relief valve secured in sealed communication with said air relief port to admit ambient air flow into said socket through said air relief port and to prevent flow of liquid out of said socket through said air relief port.

2. A liquid dispenser according to claim 1 wherein said annular socket wall is internally threaded to receive an externally threaded neck surrounding said mouth of said closed liquid beverage container, and said socket lower portion includes a transverse socket floor located at the bottom of and surrounded by said socket wall, and both said liquid drain port and said air relief port are located in said socket floor.

3. A liquid dispenser according to claim 2 further comprising an air vent tube extending upwardly from said air relief port in said socket floor to above said annular socket wall and terminating in a distal tip with an annular check valve engaging neck located at said distal tip.

4. A liquid dispenser according to claim 3 wherein said check valve is comprised of a flexible sleeve having an open lower inlet end engaged on said annular check valve engaging neck and an opposite open collapsible outlet end.

5. A liquid dispenser according to claim 4 wherein said flexible sleeve is formed from a single sheet of liquid impervious material configured in the shape of a pair of mirror image trapezoidal portions sharing a common minor base, and said sheet of material is perforated at the center of said common minor base, and said nonparallel sides of each of said mirror image trapezoidal portions are sealed throughout their lengths to the corresponding nonparallel sides of the other trapezoidal portion, whereby said common minor base of said mirror image trapezoidal portions forms said lower inlet end.

6. A liquid dispenser according to claim 5 wherein said sheet of liquid impervious material is rubber and said nonparallel sides of said mirror image trapezoidal portions of said sheet are sealed by fusion.

7. An apparatus for controlled delivery of a beverage from an inverted beverage container comprising a container stabilizing base having a concave upwardly directed socket defining a cylindrical, annular socket wall open at its top and including a beverage container coupling, a liquid drain port in said socket formed beneath said beverage container coupling, an air relief port in said socket separate from said liquid drain port and also formed beneath said beverage container coupling, a manual liquid dispensing valve located on said base in lateral displacement from said socket and operable to selectively block and permit passage of liquid therethrough, a liquid passageway through the structure of said base extending between said liquid drain port and said manual dispensing valve and isolated from ambient air, an air passageway in said base extending between said air relief port and ambient air, and an air relief check valve secured in sealed communication with said air relief port to admit air flow therefrom and prevent liquid flow thereto.

8. An apparatus according to claim 7 wherein a transverse floor is formed in said socket within the confines of said annular socket wall, and said air relief port and said liquid drain port are both formed in said socket floor, and further comprising a rigid tubular air inlet duct extending upwardly from said air relief port and terminating above said annular socket wall in an air relief valve coupling tip to which said air relief check valve is releaseably attached.

9. An apparatus according to claim 8 wherein said air relief check valve is formed of a flexible, water impervious material shaped as a collapsible, tubular structure having an inlet end with an inlet opening therein mounted on said coupling tip and an opposite outlet end with an outlet opening therein.

10. An apparatus according to claim 9 wherein said tubular structure is formed from a pair of congruent layers of said flexible, water impervious material having side edges that are sealed throughout between said inlet and outlet openings.

11. An apparatus according to claim 10 wherein said congruent layers are trapezoidal in shape with their minor bases at said inlet end and their major bases at said outlet end, whereby said side edges of each layer are nonparallel edges.

12. An apparatus according to claim 10 wherein said air relief check valve is formed from a single sheet of said flexible, water impervious material.

13. An apparatus according to claim 12 wherein said single sheet of flexible water impervious material is rubber.

14. An apparatus according to claim 7 wherein said stabilizing base is formed as a spoked, wheel-shaped structure with a hub formed by said socket and a peripheral rim upon which said spigot is mounted.

15. An apparatus according to claim 14 wherein said stabilizing base includes a plurality of spokes extending between said socket and said rim, and at least one of said spokes is hollow and forms said liquid passageway.

16. An apparatus according to claim 7 wherein said container coupling is formed by threads on the interior surface of said cylindrical annular socket wall, and said threads have a size and pitch that mate with threads on necks of commercially available two liter plastic beverage bottles.

17. In combination, a beverage container stand having a periphery and a central, concave upwardly facing socket having a floor surrounded by an upright, cylindrical socket wall, a liquid drain port and a separate air relief port, both defined in said socket floor, a spigot for dispensing liquid, located at said periphery of said stand, a laterally enclosed liquid passage leading from said spigot to said liquid drain port, an air passage extending from said air relief port to ambient atmosphere, a one way valve in sealed communication with said air relief port and oriented to admit fluid flow through said air relief port into said socket and prevent fluid flow from said socket out of said air relief port, and an inverted beverage container having a mouth with a neck and containing liquid with said neck sealed fluid tight to said upright socket wall so that said mouth of said beverage container resides in open communication with said socket floor.

18. A combination according to claim 17 wherein said beverage container is a plastic, multiliter bottle and said neck thereof is externally threaded and said upright socket wall is formed with mating threads on its internal surface.

19. A combination according to claim 17 further comprising an air inlet tube extending from said air relief port upwardly to above said cylindrical socket wall, and said one way valve is attached to the upper extremity of said air inlet tube.

20. A combination according to claim 19 wherein said one way valve is formed of a flexible, water impervious material shaped as a collapsible, tubular structure having an inlet end with an inlet opening therein releaseably coupled to said upper extremity of said air inlet tube and an opposite outlet end with an outlet opening therein, and said tubular structure is formed from a pair of congruent layers of flexible rubber having side edges sealed throughout between said inlet and outlet openings.
